(19) United States
(12) Patent Application Publication
(10) Pub. No.: US 2001/0013440 A1
(43) Pub. Date: Aug. 16, 2001

(54) SELECTIVE FOUR WHEEL DRIVE TRANSMISSION FOR ALL-TERRAIN VEHICLE

(76) Inventors: KAZUHIKO IZUMI, IWATA-SHI (JP); KATSUSHI TAKAHASHI, IWATA-SHI (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/271,631

(22) Filed: Mar. 17, 1999

(51) Int. Cl. B60K 17/344; B60K 17/354

(52) U.S. Cl. 180/247; 180/248

(57) ABSTRACT

An all-terrain vehicle has a selectively engageable four wheel drive system. The system has dedicated rear wheel drive and selectively engageable front wheel drive. The front wheel drive is engaged within the differential housing. A differential input shaft extends into the differential housing. A stub shaft is journaled for rotation within the housing. A sleeve slides relative to the two shafts and couples the two through a coupling configuration. The coupling configuration results from the externally splined ends of the two shafts and the internally splined surface of the sleeve. The positioning of the sleeve is controlled by a shift fork. The shift fork is moved by an actuator in response to a signal produced by a control unit. A switch allows an operator to instruct the control unit when to engage and disengage the front wheel drive system.

### BACKGROUND OF THE INVENTION

1. Field of the Invention

The present invention generally relates to a drive train for an all-terrain vehicle. More particularly, the present invention relates to a mechanism for selectively engaging a front wheel drive of such a vehicle.

2. Description of Related Art

All-terrain vehicles are commonly equipped with two wheel drive and four wheel drive systems. In the latter type a shifting system may be provided that allows an operator to selectively engage the wheels that are not continuously driven with a drive shaft. Such a shifting system traditionally uses a mechanism located along the respective drive shaft between the associated differential gear and the transfer case. Thus, the shifting system selectively couples the drive shaft and an input shaft of the selectively-driven differential.

Such shiftable drive systems involve complicated structures and many interlocking components. The components must be supported by the vehicle undercarriage, or frame, and necessarily result in increased weight to the vehicle. The increased weight is a distinct disadvantage. Additionally, positioning the shifting system at a location between the selectively-driven differential and the drive shaft can reduce the integrity of the drive train. This reduced integrity is partially a result of the added components and numerous universal joints required to flexibly couple the drive shaft and the differential input shaft.

### SUMMARY OF THE INVENTION

Thus, a transmission is desired that will reduce the overall weight of the vehicle through a reduction in shifting system components. In addition, a transmission is desired that can increase the integrity of such a shifting system by creating a more compact and simplified structure involving less moving components.

Accordingly, one aspect of the present invention involves a selective drive engaging mechanism for a motor vehicle that has a differential gearing arranged between two selectively-driven wheels of the motor vehicle. The differential gearing is configured to drive the two wheels and has an outer differential carrier. A transfer coupling, which is journaled within the differential carrier, includes a differential input shaft and a stub shaft. An engaging means selectively couples the input shaft and the stub shaft together such that power can be transmitted through the transfer coupling from the differential input shaft to the wheels.

Another aspect of the present invention involves a selective drive engaging mechanism for a motor vehicle. The mechanism includes a differential gear train contained within a differential housing. A train shaft drives the differential gear train. A differential input shaft, which is journaled within the differential housing, is connected to a universal joint at an input end of the differential housing. A sleeve slides along the train shaft and selectively slides onto the input shaft. The sleeve also has a coupling configuration that enables it to selectively couple the train shaft to the input shaft. An actuator fork, which contacts the sleeve, selectively positions the sleeve relative to the input shaft to control whether the train shaft and the input shaft are coupled by the sleeve.

A further aspect of the present invention involves a motor vehicle having a pair of continuously-driven wheels, a pair of selectively-driven wheels, an engine, and a transfer case connected to the engine. A continuously-driven drive shaft, which is connected to the transfer case, drives the continuously-driven wheels. A selectively-driven drive shaft, which is also connected to the transfer case, selectively drives the selectively-driven wheels. A selectively-driven differential comprising a differential carrier, an input shaft and a pair of output shafts is also provided. The input shaft is connected to the selectively-driven drive shaft. The input shaft and the output shafts are capable of being selectively coupled with the differential carrier such that the selectively-driven wheels can be selectively engaged with the selectively-driven drive shaft through the selectively-driven differential.

### BRIEF DESCRIPTION OF THE DRAWINGS

These and other features, aspects and advantages of the present invention will now be described with reference to the drawings of a preferred embodiment, which embodiment is intended to illustrate and not to limit the invention, and in which drawings:

FIG. 1 is a side schematic view of a motor vehicle having a transmission employing features, aspects and advantages in accordance with the present invention;

FIG. 2 is a top schematic view of the motor vehicle of FIG. 1; and

FIG. 3 is top partially sectioned view of a transmission having features, aspects and advantages in accordance with the present invention.

### DETAILED DESCRIPTION OF THE PREFERRED EMBODIMENTS OF THE INVENTION

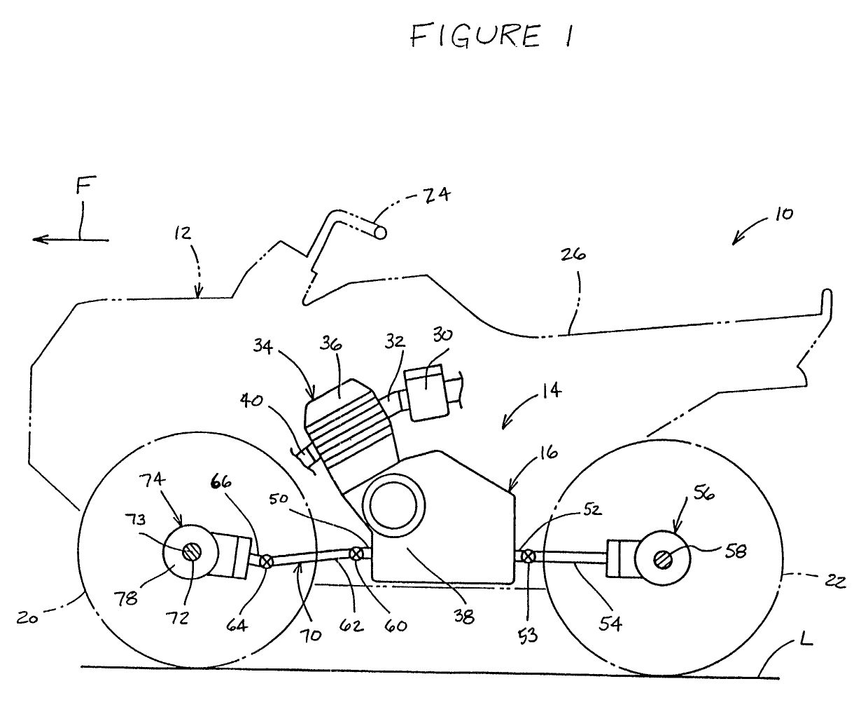

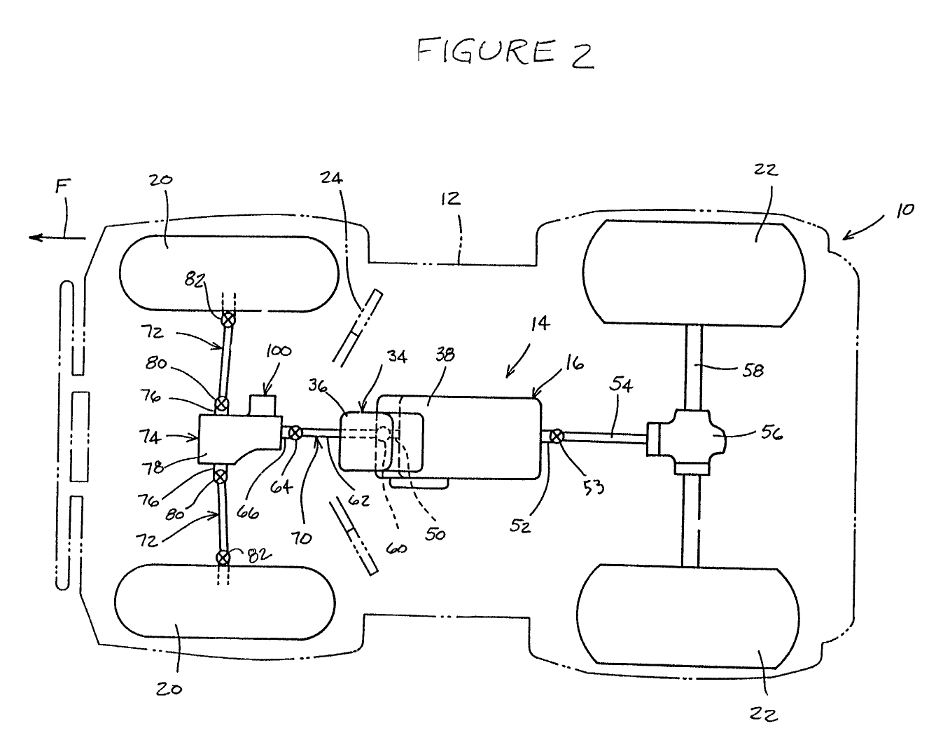

With reference to FIGS. 1 and 2, schematic illustrations of a motor vehicle, indicated generally by reference numeral 10, are presented. The illustrated motor vehicle is a four wheel all-terrain vehicle; however, as will be appreciated by those of skill in the art, the illustrated motor vehicle is purely exemplary and various features, aspects and advantages of the present transmission may find utility in a number of other vehicle applications. The motor vehicle 10 is generally comprised of a body 12, an engine 14 and a transmission 16.

The body 12 is supported by a frame (not shown). The frame carries a pair of front wheels 20 and a pair of rear wheels 22 in a known manner. The motor vehicle moves along the ground surface L on these wheels 20, 22. The body also has a steering handle 24, which is connected to the front wheels 20 in a known manner for steering the motor vehicle 10. Controls and gauges may be mounted on or around the steering handle 24. Rearward of the steering handle 24, the motor vehicle has a longitudinally extending straddle seat 26 and a fuel tank (not shown). The straddle seat 26 is so called because the operator and any passengers sit on the seat with a leg on either side of the seat 26.

The engine 14 is desirably of the two-stroke one cylinder configuration and is arranged within the body beneath at least a portion of the seat 26. As will be recognized, the engine 14 may also be of any other configuration and operating principle (i.e., one cylinder, two cylinder, four cylinder, etc. and two-stroke or four-stroke). The illustrated engine desirably receives an air-fuel mixture from a carburetor 30. However, as is known, the engine may also be fuel-injected (i.e., either direct injected or indirect injected). The air-fuel mixture from the carburetor 30 is passed through an intake pipe 32 into a combustion chamber (not shown) arranged within a cylinder block 34 and a cylinder head 36 of the engine 14 for combustion. Upon ignition, the air-fuel mixture rapidly expands in the combustion chamber (not shown), defined by a recess in the cylinder block 34 and the cylinder head 36, and may power a piston (not shown) downward for a power stroke. The spent gases resulting from the ignition are subsequently exhausted from the cylinder block 34 through an exhaust system 40 as is generally known.

The piston (not shown) is connected to a crankshaft (not shown) in a known manner such that the crankshaft (not shown) is driven for rotation by the translational movement of the piston (not shown) within the cylinder block 34. The crankshaft (not shown) is preferably journaled for rotation within a crankcase 38 as is known. The crankshaft (not shown) then transfers its rotational power to a pair of output shafts 50, 52 in a known manner. Notably, the front output shaft 50 drives the front wheels 20 and the rear output shaft 52 drives the rear wheels 22 as will be described below. It is recognized that a single output shaft may be used in some configurations. It is further recognized that this initial power transfer may also be accomplished with belts, chains and the like.

The rear output shaft 52 extends rearward from a transfer case (i.e., a lower portion of the crankcase 38). The rear output shaft 52 is coupled to a rear drive shaft 54 by a universal joint 53 to allow flexibility in the connection. A rear differential 56 transfers the power from the rear drive shaft 54 to a rear axle 58 in a known manner. The rear axle 58, in turn, drives the rear wheels 22 to propel the motor vehicle 10 along a desired tack.

The front output shaft 50 extends forward from the transfer case 38. A universal joint 60 connects the front output shaft 50 to a secondary drive shaft 62. The secondary drive shaft 62 rotatably powers a differential input shaft 66 through a second universal joint 64. The front output shaft 50, secondary drive shaft 62 and differential input shaft 66 combine to form a front drive element 70. The front drive element 70 is selectively engageable as a unit with the front wheels 20 through the differential arrangement that will be discussed in detail below. It should be recognized that the front drive element 70 might also comprise the secondary drive shaft 62 and a single universal joint in some configurations.

With reference now to FIG. 2, the rotational power of the differential input shaft 66 is selectively transferred to the front axles 72 through the front differential 74. Specifically, a pair of output shafts 76 extend transversely outward from a differential carrier 78. A corresponding pair of universal joints 80 connect the output shafts 76 to the proximal end of the front axles 72. The front axles 72 are thereby driven about a central axis 73. The distal ends of the front axles 72, in turn, power the front wheels 20 through universal joints 82.

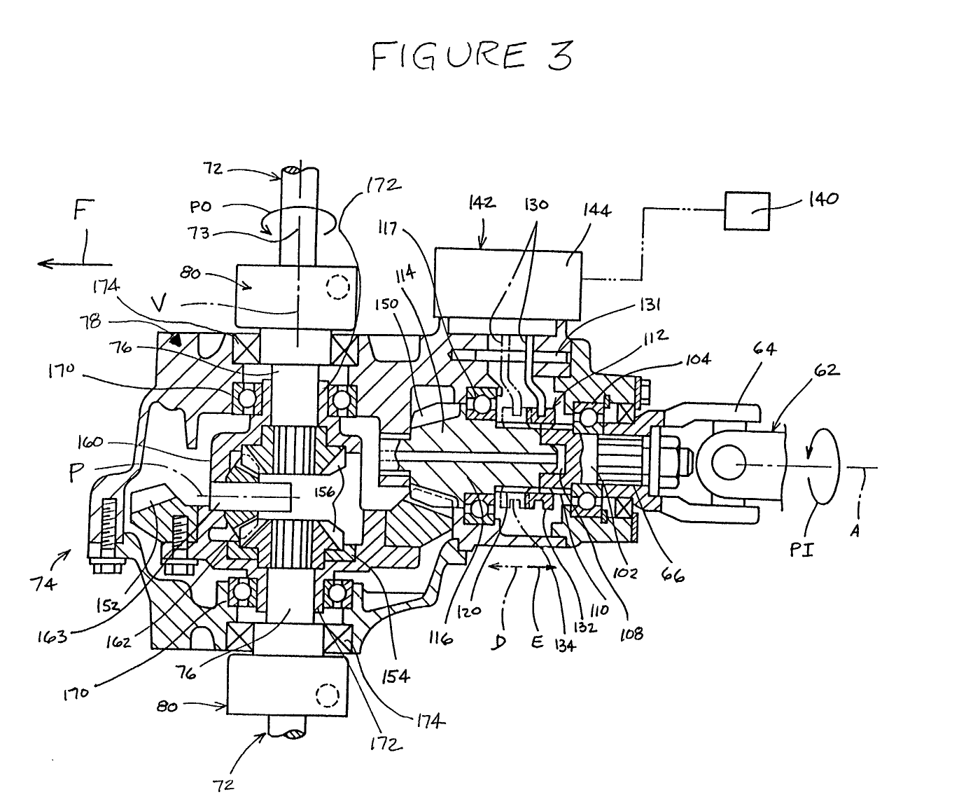

With reference now to FIG. 3, a two-wheel/four-wheel drive selector having features, aspects and advantages in accordance with the present invention will now be described in detail. The secondary drive shaft 62 is rotated about a drive axis A as indicated in FIG. 3. The rotational movement of the shaft 62 desirably creates a power input PI that may be used to selectively drive the front wheels 20 through the differential 74. The secondary drive shaft 62 is preferably coupled to the differential input shaft 66 through the second universal joint 64. The universal joint allows movement of the two shafts relative to one another and also compensates for dimensional tolerance stack-ups. Because universal joints are considered well known to those of ordinary skill in the art, further description is deemed unnecessary.

The proximal end of the input shaft 66 has a threaded end to which the universal joint 64 is attached. In the illustrated embodiment, a washer and nut secure a collar of the universal joint 64 to the input shaft 66. Additionally, the input shaft 66 and the universal joint 64 are desirably splined together such that the two rotate together without slippage. Advantageously, an oil seal may be provided along a shoulder of the collar of the universal joint 64. The oil seal protects the internal components of the differential 74 from outside debris and foreign matter.

The input shaft 66, which is partially housed within a differential carrier 78, or housing, preferably forms an input side 102 of a transfer coupling and is carried by a ball bearing 104. Desirably, the ball bearing 104 journals the input shaft for rotation relative to a differential carrier 106. The distal end of the illustrated input shaft 66 has an internal alignment bore 108 and external splines 110. The splines 110 may abut on the ball bearing 104 which journals the input shaft 66.

A sliding sleeve 112 is capable of translation relative to the input shaft 66 to selectively engage a stub shaft 114. The stub shaft 114 thus forms an output side 116 of the transfer coupling and may be journaled for rotation by a second ball bearing 117. To allow the sliding sleeve 112 to couple the two shafts 102, 114 together, the stub shaft 114 also may have external splines 120. Other coupling arrangements that allow selective engagement of the two shafts may also be used. As will be recognized by those of skill in the art, the sliding sleeve 112 preferably has internal splines (not shown) which complement the external splines 110, 120 and the external splines 110, 120 of both shafts are desirably of the same size and configuration as the other.

A shifting fork 130 may be used to selectively position the sliding sleeve 112 in either an engaging position 132 or a disengaging position 134. The shifting fork 130 may be mounted to a support shaft 131 that is restricted to translation within the differential carrier 106. The support shaft may advantageously limit the rotational movement of the shifting fork 130. The distal end of the shifting fork 130 preferably rides within a circumferential groove within the sliding sleeve 112. Thus, the sleeve 112 is capable of freely rotating with the stub shaft 114 while the shifting fork 130 maintains contact with the sleeve 112.

The total travel of the sliding sleeve 112 is desirably restricted to ensure that the sliding sleeve 112 does not disengage when it should be engaging and vice versa. The engaging position 132 and the disengaging position 134, therefore, define a desired travel distance for the sliding sleeve 112. The travel distance may be limited by a control actuator, as discussed below.

The shifting fork 130 initiates an engaging movement E or a disengaging movement D of the sliding sleeve 112 as dictated by an operator controlled control switch 140. The operator controlled control switch 140 can be arranged anywhere on the motor vehicle 10. Desirably, the-switch 140 is located on the steering handle 24 or in another easily manipulated location. The switch 140 is in electrical communication with a control unit 142 that may be mounted adjacent to the differential 74. The control unit 142 enables a selection between two wheel and four wheel drive. It is anticipated that the control unit 142 may be located in a variety of positions with proper relays and electrical or pneumatic connections, for instance.

In the illustrated embodiment, the control unit 142 also houses an actuator 144. The actuator 144 can be a solenoid or the like. In one embodiment, the front wheel drive transmission may be maintained in a disengaged relationship through a biasing component, such as a spring (i.e., the sleeve 112 is urged into the disengaged position 134) and flipping the switch 140 charges the actuator 144 through the control unit 140. The charged actuator may then move the sleeve 112, via the shifting fork 130, against the biasing force of the biasing component into the engaging position 132 and bring the front wheel drive transmission into engagement with the secondary drive shaft 62. Thus, on shut down, the front wheel drive transmission will be disengaged because of the initial bias. Other embodiments not utilizing such a biased shifting fork 130 are also contemplated. As will be recognized, the control unit 142 may be separate from the differential carrier 106 while the solenoid that operates the shift fork 130 may be arranged within the differential carrier 106. In addition, the control unit 142, or another component, may store sufficient energy to shift the shift fork 130 into the disengaged position 134 either on or after engine shutdown. Moreover, in applications having a battery, such energy may be drawn from the battery.

A distal end of the stub shaft 114 preferably forms a bevel pinion 150. The bevel pinion 150 drives a beveled crown wheel 152. The crown wheel 152 is secured to a differential case 160 that is carried in ball bearings 170 at both ends. The illustrated crown wheel 152 is secured via a threaded fastener; however, other fastening arrangements are also contemplated. For instance, the crown wheel may be integral with the differential case 160, may be welded, brazed or adhered thereto, or may be fastened using other standard fasteners. The ball bearings 170 preferably are carried within axle casings in the differential carrier 78.

The differential case 160 preferably contains a pair of differential side gears 156 and a differential pinion 162. The differential pinion freely rotates about a pinion axis P on a pin 163 while the differential case 160 and the side gears 156 rotate about an axis V, which is substantially normal to axis P. The output shafts 76 of the differential 74 pass through bosses 172 of the differential case 160 and have their ends splined into the corresponding side gears 156 with which the pinion 162 meshes. A set of oil seals 174 protect the internal components, which are inside the differential carrier 106, from dirt and other foreign debris.

Once the front differential 74 is engaged with the front output shaft 50, the front wheels 20 are driven by the power output PO. The differential 74 divides the torque from the engine output shaft 50 equally between the two front axles 72. The torque distribution occurs regardless of the fact that they may be rotating at different speeds, for instance, on rounding a corner.

The above-described invention has the advantage of providing a compact shifting arrangement. Because the shifting is internal to the differential housing, the components required to connect the shifting mechanism to the differential are eliminated. Additionally, because the structure of the differential housing can be used for the shifting mechanism as well as the differential, the number of components and the overall weight of the mechanism can be reduced. Accordingly, a lighter, more compact and mechanically sound mechanism results.

While the illustrated embodiment utilizes dedicated rear-wheel drive, other drive-wheel configurations are also contemplated. For instance, the front wheels may be the dedicated set with the rear wheels being selectively engageable. Additionally, it is envisioned that both the front wheels and the rear wheels may be selectively engageable as desired by the operator such that neither set is dedicated as the drive wheels. Moreover, it is anticipated that the shifting may also be automatically controlled such that the non-dedicated set or set not driving the motor vehicle can be engaged if the driving set begin to slip. Many other variations employing all or select features, aspects and advantages of the present transmission may become readily apparent to one of ordinary skill in the art in light of the foregoing disclosure.

Thus, although this invention has been described in terms of a certain embodiment, other embodiments apparent to those of ordinary skill in the art also are within the scope of this invention. Therefore, various changes and modifications may be made without departing from the spirit and scope of the invention. Accordingly, the scope of the invention is intended to be defined only by the claims that follow.

What is claimed is:

1. A selective drive engaging mechanism for a motor vehicle, the mechanism comprising a differential gear arranged between two wheels and configured to drive the two wheels, the differential gear comprising an outer differential carrier, a transfer coupling journaled within the differential carrier which comprises a differential input shaft and a stub shaft, an engaging means selectively coupling the input shaft and the stub shaft together such that power can be transmitted from the differential input shaft to the wheels.

2. The mechanism of claim 1, wherein the engaging means is capable of being controlled by an operator of the motor vehicle from a switch.

3. The mechanism of claim 1 further comprising a control unit, wherein the control unit actuates the engaging means.

4. The mechanism of claim 1 further comprising an actuator which operatively controls the positioning of the engaging means.

5. The mechanism of claim 1 wherein the two wheels are front wheels.

6. A selective drive engaging mechanism for a motor vehicle, the mechanism comprising a differential gear train contained within a differential housing, a shaft driving the differential gear train, a differential input shaft journaled within the differential housing and being connected to a universal joint, a sleeve configured to slide along the shaft and to slide onto the input shaft, the sleeve further having a coupling configuration to allow selective coupling of the shaft to the input shaft, and an actuator fork contacting the sleeve and selectively controlling the positioning of the sleeve relative to the input shaft.

7. The mechanism of claim 5, wherein the coupling configuration comprises an externally splined surface on the shaft and the input shaft and an internally splined surface on the sleeve.

8. The mechanism of claim 5 further comprising an actuator, wherein the actuator moves the actuator fork.

9. The mechanism of claim 7 further comprising a control unit, wherein the control unit transmits a signal to the actuator for controlling the movement of the actuator fork.

10. The mechanism of claim 8 further comprising a switch, wherein the switch controls the transmission of the signal from the control unit.

11. A motor vehicle having a pair of rear wheels, a pair of front wheels, an engine, a transfer case connected to the engine, a rear drive shaft connected to the transfer case for driving the rear wheels, a front drive shaft connected to the transfer case, a front differential comprising a differential carrier, an input shaft and a pair of output shafts, the input shaft being connected to the front drive shaft, the input shaft and the output shafts being selectively coupleable with the differential carrier such that the front wheels are capable of being selectively engaged with the front drive shaft through the front differential.

12. The motor vehicle of claim 10 further comprising an actuator, the actuator positioning a coupling between the input shaft and the output shafts such that the input shaft and the output shaft are selectively coupled together.

13. The motor vehicle of claim 11 further comprising a control unit, wherein the control unit emits a signal to control the actuator.

14. The motor vehicle of claim 12 further comprising a switch, wherein the switch activates the control unit.
